(19) United States
(12) Patent Application Publication
(10) Pub. No.: US 2012/0026381 A1
(43) Pub. Date: Feb. 2, 2012

(54) DIGITAL IMAGE SIGNAL PROCESSING METHOD, DIGITAL IMAGE SIGNAL PROCESSING APPARATUS AND RECORDING MEDIUM HAVING RECORDED THEREON THE METHOD

(75) Inventors: Seung-yun Lee, Hwaseong-si (KR); Chan-sup Kim, Incheon (KR)

(73) Assignee: Samsung Electronics Co., Ltd., Suwon-si (KR)

(21) Appl. No.: 13/163,041

(22) Filed: Jun. 17, 2011

(30) Foreign Application Priority Data
Jul. 27, 2010 (KR) 10-2010-0072481

(51) Int. Cl. H04N 5/222; G09G 5/00

(52) U.S. Cl. 348/333.12; 345/671; 345/625; 348/E05.024

(57) ABSTRACT

A digital image signal processing method, a digital image signal processing apparatus, and a computer readable medium having recorded thereon the method, the method including generating a first display image, in which a plurality of first images having a first size are arranged in a single screen image; displaying the first display image; selecting at least one of the plurality of first images in the first display image; generating a second display image, in which a second image that corresponds to the selected first image and has a second size larger than the first size is arranged in a display area of the selected first image; and displaying the second display image.

### CROSS-REFERENCE TO RELATED PATENT APPLICATION

This application claims the benefit of Korean Patent Application No. 10-2010-0072481, filed on Jul. 27, 2010, in the Korean Intellectual Property Office, the entire disclosure of which is incorporated herein by reference.

### BACKGROUND

1. Field of the Invention

The invention relates to a digital image signal processing method, a digital image signal processing apparatus, and a recording medium having recorded thereon the digital image signal processing method, the method including enlarging a portion of a displayed image.

2. Description of the Related Art

A plurality of thumbnail images are displayed on a single screen image in a preview mode. However, due to small sizes of the thumbnail images, it is difficult to recognize details of objects in the thumbnail images. Furthermore, it is difficult to evaluate the quality of images displayed on LCD panel of a digital camera. For example, it may be difficult to recognize motion blurs in thumbnail images displayed on an LCD panel of a digital camera.

### SUMMARY

Therefore, there is a need in the art for a digital image signal processing method, the method including generating a first display image in which a plurality of first images are arranged; displaying the first display image as a single screen image; selecting a first image from the displayed plurality of first images in the first display image; generating a second display image comprising a second image in which a portion of the selected first image is enlarged, wherein the second image is displayed in a display area of the second display image approximately corresponding to a display area of the selected first image in the first display image; and displaying the second display image as single screen image.

Generating a second display may include retrieving a larger sized image of the selected first image than used to generate the first display image; and generating the enlarged portion of the selected first image from the retrieved larger sized image.

Generating a second display image may include generating a second display image wherein the unselected first images are displayed in display areas of the second display image approximately corresponding to display areas of the unselected first images in the first display image.

The second image may be displayed in a display area of the second display image approximately corresponding to a display area of the selected first image in the first display image, and the second image and the selected first image have approximately the same size.

The digital image signal processing method may include generating another second display image comprising a second image in which a different portion of the selected first image is enlarged, wherein the second image is displayed in a display area of the second display image approximately corresponding to a display area of the selected first image in the first display image; and displaying the another second display image as single screen image.

The digital image signal processing method may include detecting an object area in the selected first image, and wherein the portion of the selected first image enlarged comprises at least some of the object area.

The digital image signal processing method may include detecting a face area in the selected first image, and wherein the portion of the selected first image enlarged comprises at least some of the detected face area.

The digital image signal processing method may include selecting a plurality of first images from the first images; detecting a plurality of face areas in each of the selected first images, and wherein the step of generating a second display image may include generating a second display image comprising second images in which a portion of the corresponding selected first image is enlarged, wherein each of the second images is displayed in a display area of the second display image approximately corresponding to a display area of the corresponding selected first image in the first display image, and wherein the portion of the corresponding selected first image enlarged comprises at least a part of the corresponding detected face area of the plurality of face areas, if a face area is detected in the corresponding selected first image.

The face areas depict faces may be of the same person.

The digital image signal processing method may include selecting a plurality of first images from among the first images; detecting face areas in each of the selected first images, and wherein the step generating a second display image may include generating a second display image comprising second images in which a portion of the corresponding selected first image is enlarged, wherein each of the second images is displayed in a display area of the second display image approximately corresponding to a display area of the corresponding selected first image in the first display image, wherein the portion of the corresponding selected first image enlarged is a face if a face is detected, and if a face is not detected then the corresponding selected first image enlarged is one of: an object detected and a focus area detected.

The digital image signal processing method may include detecting a focus area for the selected first image, wherein the portion of the selected first image enlarged is at least part of the focus area.

A computer readable medium is disclosed. The computer readable medium may be a non-transitory computer readable recording medium having recorded thereon computer readable instruction, that when executed by a computer cause the computer to execute the methods of the invention described herein.

According to another aspect of the invention, there is provided a digital image signal processing apparatus including a first display image generating unit for generating a first display image, in which a plurality of first images having a first size are arranged in a single screen image; a selecting unit for selecting at least one of the plurality of first images in the first display image; a second display image generating unit for generating a second display image, in which a second image that corresponds to the selected first image and has a second size larger than the first size is arranged in a display area of the selected first image; and a display unit for displaying the second display image.

The digital image signal processing apparatus may further include a first image detecting unit for detecting the selected first image in an image file including the selected first image and the second image, wherein the images depict a single scene and having different sizes; and a second image detecting unit for detecting the second image in the image file.

In the second display image, the unselected first images may be displayed, and the second image may be displayed in the display area of the selected first image.

In the second display image, a portion of the second image may be displayed in the display area of the selected first image, wherein the size of the portion of the second image may correspond to the size of the display area of the selected first image.

The digital image signal processing apparatus may further include generating another second display image, in which the portion of the second image displayed in the display area of the selected first image is replaced with another portion of the second image, wherein the size of the other portion of the second image corresponds to the size of the display area of the selected first image.

The digital image signal processing apparatus may further include an object detecting unit for detecting an object area with respect to the at least one selected first image, wherein the second display image generating unit may generate a second display image, in which the portion of the second image includes at least a portion of the object area.

The digital image signal processing apparatus may further include a face detecting unit for detecting a face area with respect to the at least one selected first image, wherein the second display image generating unit may generate a second display image, in which the portion of the second image includes at least a portion of the face area.

The selecting unit may select a plurality of first images from among the first images, the face detecting unit may detect face areas corresponding to each of the selected first images, and the second display image generating unit may generate a second display image, in which portions of second images respectively corresponding to the selected first images are arranged in display areas of the corresponding selected first images.

The face areas respectively corresponding to the selected first images may depict faces of a single person.

The face detecting unit may detect face areas corresponding to each of the selected first image, and the second display image generating unit may generate a second display image, in which the portions of the second images are replaced with other portions of the second images including at least a portion of face areas of a person different from the person corresponding to the face areas included in a previous second display image.

The digital image signal processing apparatus may further include a focus area detecting unit for detecting a focus area with respect to the at least one selected first image, wherein the second display image generating unit may generate a second display image, in which the portion of the second image includes at least a portion of the focus area.

### BRIEF DESCRIPTION OF THE DRAWINGS

The above and other features and advantages of the invention will become more apparent by describing in detail exemplary embodiments thereof with reference to the attached drawings in which:

FIG. 1 is a block diagram of a digital image signal processing apparatus according to an embodiment of the invention;

FIG. 2 is a flowchart for describing a digital image signal processing method according to an embodiment of the invention;

FIG. 3 is a diagram for describing an example of image file structures;

FIGS. 4 through 6 are diagrams for describing an example of applications of the digital image signal processing method according to an embodiment of the invention as shown in FIG. 2;

FIG. 7 is a flowchart for describing a digital image signal processing method according to another embodiment of the invention;

FIGS. 8 through 10 are diagrams for an example of applications of the digital image signal processing method according to an embodiment of the invention as shown in FIG. 7; and

FIGS. 11 through 14 are diagrams for describing a digital image signal processing method according to another embodiment of the invention.

### DETAILED DESCRIPTION

Exemplarily embodiments of digital image signal processing methods, digital image signal processing apparatuses, and a recoding medium having recorded thereon the methods are described below with reference to accompanied drawings.

A digital image signal processing apparatus may be a device as a digital camera, a digital camcorder, a personal digital assistant (PDA), a TV, a digital picture frame, a mobile phone, a portable multimedia player (PMP), or the like.

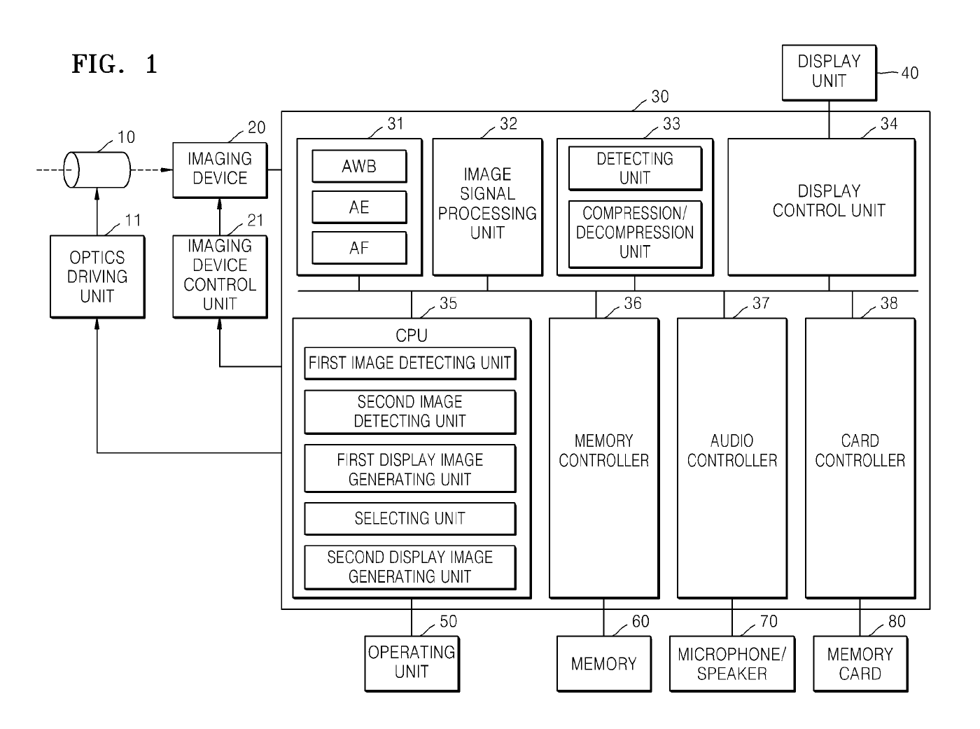

FIG. 1 is a block diagram of a digital image signal processing apparatus according to an embodiment of the invention.

Referring to FIG. 1, the digital image signal processing apparatus may include an optics 10, an optics driving unit 11 for driving the optics 10, an imaging device 20, an imaging device control unit 21, a digital signal processor (DSP) 30, a display unit 40, an operating unit 50, a memory 60, a microphone/speaker 70, and a memory card 80.

The optics 10 may include a lens for concentrating optical signals, an iris for controlling an amount of the optical signals, and a shutter for controlling a time for input of the optical signals. The lens may include a zoom lens for narrowing or widening a picture angle according to focal lengths and a focus lens for focusing an object. Each of the lenses as stated above may be either an individual lens or a collection of lenses. The shutter may be a mechanical shutter, in which a screen moves in a vertical direction. Alternatively, supply of electric signals to the imaging device 20 may be controlled instead of arranging a shutter unit.

The optics driving unit 11 for driving the optics 10 may move the lens, open/close the iris, and operate the shutter to perform operations, such as auto-focusing, auto-exposure, iris controlling, zooming, and focus changing. The optics driving unit 11 may receive a control signal from the DSP 30 and control the optics 10 according to the control signal.

The imaging device 20 includes a photoelectric conversion device that receives an optical signal input via the optics 10 and converts the optical signal to an electric signal.) Examples of the photoelectric conversion device are a charge-coupled device (CCD) sensor array and a complementary metal-oxide semiconductor (CMOS) sensor array. Furthermore, the imaging device 20 may include a correlated double sampling (CDS)/ amplifier (AMP) that eliminates low frequency noises included in an electric signal output by the imaging device 20 and amplifies the electric signal to a predetermined level. Furthermore, the imaging device 20 may further include an analog-digital (AD) converter that performs digital conversion on an electric signal output by the CDS/AMP to generate a digital signal.

Although the imaging device 20 and the components stated above are included in a single block, that is, the components are included in the imaging device 20 in the current embodiment, the invention is not limited thereto, and the imaging device 20 and the components stated above may, for example, be included in separate blocks or included in the DSP 30.

The optics driving unit 11 and the imaging device control unit 21 may be controlled according to a timing signal supplied by a timing generator (TG). Although not shown, the TG may be included in the DSP 30. However, the invention is not limited thereto. For example, in a digital single lens reflex (DSLR) camera, the TG may be arranged in a lens unit attached to a body.

The TG outputs a timing signal to the imaging device 20 to control a period of time for exposure of each of pixels of the photoelectric conversion device or control read-out of electric charges. Therefore, the imaging device 20 may provide image data corresponding to a frame image according to a timing signal provided by the TG.

An image signal provided by the imaging device 20 is input to a pre-processing unit 31 of the DSP 30. The pre-processing unit 31 performs calculations for automatic white balance (AWB), automatic exposure (AE), and automatic focusing (AF). Results of the calculations for AWB and AE are fed back to the imaging device control unit 21 so that the imaging device control unit 21 may acquire an image signal with suitable color outputs and suitable exposure levels from the imaging device 20. Furthermore, the results of the calculations for AWB and AE may control opening/closing of the iris and shutter speed by driving an iris driving motor and a shutter driving motor of the optics driving unit 11. Furthermore, a result of the calculation of AF may be output to the optics driving unit 11 to relocate the focus lens along an optic axis. AWB, AE, and AF may be selectively applied by a user to an input image signal.

An image signal processing unit 32 performs predetermined image signal processes on an image signal to display or record the image signal. For example, the signal processing unit 32 performs image signal processes on an image signal to convert the image signal into a form suitable for human vision, e.g., gamma correction, color filter array interpolation, color matrix, color correction, and color enhancement. Furthermore, the signal processing unit 32 also performs resizing process for adjusting the size of an image.

Furthermore, the DSP 30 includes a signal processing unit 33 that performs signal processes for performing particular functions. The signal processing unit 33 may include a detecting unit that detects a desired scene or object with respect to an image signal and a compression/decompression unit. The detecting unit may detect a desired scene or object by, for example, using information regarding color components, edge components, and characteristic points of the image signal. In the invention, the face of a person may be detected in the image signal and a face area including the detected face may be located in the image signal. The invention may also provide a face detecting unit that may detect at least one face area in an image including a plurality of faces and detect face areas of each of a plurality of images. The compression/expansion unit performs compression and expansion on an image signal to which image signal processes have been performed. For example, in a case of compression, the signal processing unit 32 compresses an image signal into a compression format, such as a JPEG compression format or H.264 compression format. An image file containing image data generated through a compression process is transmitted to the memory card 80 via a card controller 38 and is stored therein. In the invention, the compression/expansion unit may generate an image file that includes a first image having a first size and a second image having a second size, where the first image and the second image are captured with respect to the same scene, and the second size is larger than the first size.

Furthermore, the DSP 30 includes a display control unit 34. The display control unit 34 controls operations for displaying an image and/or information on the display unit 40. The display unit 40 may include a liquid crystal display (LCD) device, a light-emitting diode (LED) display device, or an organic light-emitting display (OLED) device.

Furthermore, the DSP 30 includes a CPU 35 that controls overall operations of each of components. The CPU 35 and the DSP 30 may be embodied as separate chips.

In the current embodiment, the CPU 35 includes a first display image generating unit for generating a first display image, in which a plurality of first images having a first size are arranged in a single screen image. Furthermore, the CPU 35 includes a selecting unit for selecting at least one of the plurality of first images in the first display image, or for receiving a selection of one of the plurality of first images in the first display image. Furthermore, the CPU 35 includes a second display image generating unit for generating a second display image, in which a second image corresponding to the selected first image and having a second size is arranged in a display area of the selected first image, where the second size is larger than the first size.

The selecting unit may either select one of the first images automatically by a particular program or receive a selection from a user via the operating unit 50. The selecting unit selects at least one of the first images included in the first display image and displays an indication corresponding to the selection. In other words, the selecting unit may control the display control unit 34 to display edges of the selected first image with a different color.

In the second display image generating unit, the first images that are not selected and the second image, which corresponds to the selected first image, has a second size, which is larger than the first size, and is displayed in the display area of the selected first image, and may be arranged in a single screen image.

In detail, in the second display image, a portion of the second image corresponding to the size of the display area of the selected first image may be displayed in the display area of the selected first image.

Furthermore, the second display image generating unit may replace the second display image with a different second display image, by displaying a different portion of the second image corresponding to the size of the display area of the selected first image in the display area of the selected first image. The replacement may be either performed automatically by a particular program or manually by a user via the operating unit 50.

Furthermore, the second display image generating unit may generate a second display image that includes a portion of the second image that includes at least a portion of an object area detected by the detecting unit. Since the detecting unit includes the face detecting unit, a second display image including at least a portion of a detected face area may be generated. Here, the face area may be extracted from the second image. When face detection is performed on each of the first images and face areas are extracted from the second image, a second display image including at least a portion of each of the face areas may be generated. In the invention, face detection may be performed with respect to the first images, the second image, or an original image. Alternatively, face detection information recorded in an image file may be read out and a face area may be detected in the second image.

Furthermore, the second display image generating unit may generate a second display image that includes face areas corresponding to each of at least two first images from among the first images. In detail, the second display image is divided into a plurality of display areas, where the first images may be displayed in a part of the display areas, and the face areas may be displayed in the remaining part of the display areas. Here, the face areas are extracted from the second image, and may depict the same person.

Furthermore, the second display image generating unit may not only generate a second display image that includes face areas of second images, but also generate another second display image including portions of face areas of a person different from the person corresponding to the face areas included in the first second display image. In detail, the detecting unit may detect a plurality of persons and detects a plurality of face areas, where a first second display image may include a first face area from among the plurality of face areas, and a second display image may include a second face area from among the plurality of face areas. A second display image including at least a portion of a first face area of a first person corresponding to each of selected first images may be generated, and another second display image including at least a portion of a second face area of a second person corresponding to each of the first images selected either automatically or manually by a user. The second display image may be modified to generate the other second display image.

Furthermore, the CPU 35 may further include a first image detecting unit and a second image detecting unit that respectively detect a first image and a second image from an image file including the first image and the second image, wherein the images depict the same scene and have different sizes. In detail, the first image detecting unit may detect the first image having the first size from the image file after the image file has been restored by the compression/expansion unit. The second image detecting unit may detect the second image having the second size from the image file restored by the compression/expansion unit

The DSP 30 includes a memory controller 36 for controlling the memory 60, to which data of a captured image or image information are temporarily written.

Furthermore, the DSP 30 includes an audio controller 37 for controlling the microphone/speaker 70. Furthermore, the DSP 30 includes the card controller 38, which writes a captured image to the memory card 80 or reads out a stored image from the memory card 80. The card controller 38 controls writing of image data to the memory card 70 and reading out of image data or setup information stored in the memory card 70.

Furthermore, the digital image signal processing apparatus includes the operating unit 50, via which control signals of a user are input. The operating unit 50 may include a component for setting various options for operating the digital photographing apparatus and capturing an image. For example, the operating unit 50 may be embodied as buttons, keys, a touch panel, a touch screen, or a dial, and user control signals for various functions, such as turning power on/off, starting/stopping photographing, starting/stopping/searching playback, driving optics, switching mode, operating menus, and operating selections, may be input via the manipulation unit 50. For example, a shutter button may be half-pressed, fully pressed, or released by a user. An operation signal for starting focus control is output when a shutter button is half-pressed (operation 51), and the focus control is terminated when the shutter button is released. The shutter button may output an operation signal for starting photographing when the shutter button is fully pressed (operation S2). The operation signals may be transmitted to the CPU 36 of the DSP 30, and thus corresponding components may be driven.

The memory 60 may include a program storage unit for storing an operating system (OS) and application programs for operating the digital photographing apparatus. Examples of the program storage unit may be an EEPROM, a flash memory, and a ROM. Furthermore, the memory 60 may include a buffer memory for temporarily storing image data of a captured image. Examples of the buffer memory may be a SDRAM or a DRAM. The buffer memory may store image data of a plurality of images in sequential/a predetermined order, and may output image signals in the sequential/predetermined order during focusing. Furthermore, the memory 60 may include a display memory having at least one channel for displaying a first display image or a second display image. The display memory may simultaneously input and output image data to and from a display driving unit included in the display unit 40. The size and the maximum number of displayable colors depend on the capacity of the display memory.

The memory card 80 may be attached to and detached from the digital photographing apparatus, and may be an optical disc (a CD, a DVD, a Blu-ray disc, or the like), an optical-magnetic disk, a magnetic disk, or a semiconductor memory.

Hereinafter, a digital image signal processing method according to the invention will be described with reference to attached drawings.

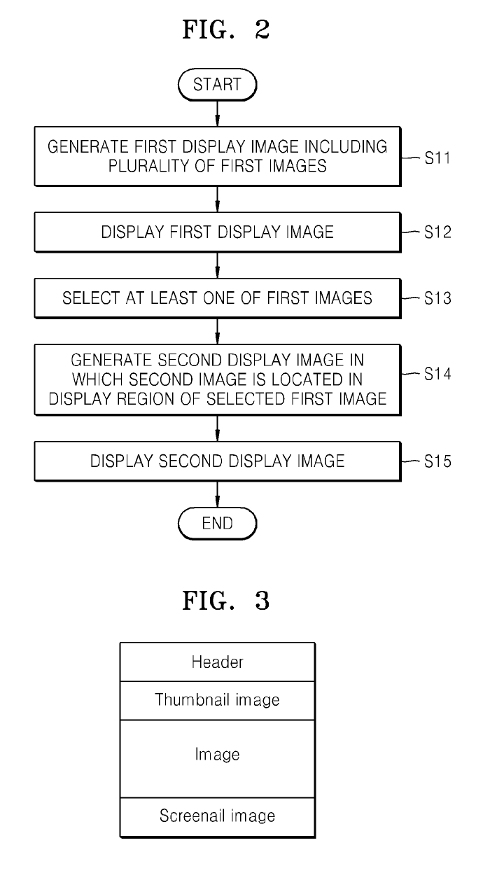

First, a digital image signal processing method according to an embodiment of the invention will be described with reference to FIG. 2.

Referring to FIG. 2, a first display image including first images having a first size is generated (operation S11).

Next, the first display image is displayed on a display unit (operation S12). Although the first display image may be displayed after the first display image has been fully generated, the invention is not limited thereto, and generation and display of the first display image may be performed substantially at the same time according to factors including display memory capacity and image signal processing speed. For example, a first portion of the first display image may be generated and displayed, and a second portion of the first display image may be generated while generating the first portion of the first display image.

One of the first images included in the first display image is selected (operation S13). The selection may be either performed automatically by a particular program or manually by a user. For example, a first image in which a face area is detected may be automatically selected from among the first images.

Especially, first images in which face areas corresponding to a single person are detected may be automatically selected.

Next, a second display image, in which a second image is displayed in a display area of the selected first image, is generated (operation S14). The second image has a second size that is larger than the first size of the first images.

Furthermore, the selected first image and the second image may depict the same scene and may be stored in the same image file. Referring to FIG. 3, an original image may be generated by capturing a particular scene, and an image file may be generated by compressing the original image. Here, a thumbnail image has a size smaller than that of the original image and a screennail image has a size larger than the first size and smaller than that of the original image. The original image may be resized. Furthermore, an image file including the original image, the thumbnail image, and the screennail image may be generated. In the image file storing the selected first image and the second image and having a structure as stated above, if the selected first image is a thumbnail image, the second image may be a screennail image. Alternatively, if the selected first image is a screennail image, the second image may be an original image. The first and second display images may be generated by detecting the selected first image and the second image in the image file, respectively. According to the invention, the second display image is not displayed by simply upscaling the selected first image. According to the invention, the second image, which is stored in the same image file as the selected first image, is detected and the second display image including a portion of the second image having the same size as the selected first image may be displayed.

Next, the second display image is displayed on the display unit (operation S15). In the same manner as with the first display image, generation and display of the second display image may be either performed sequentially or performed substantially at the same time.

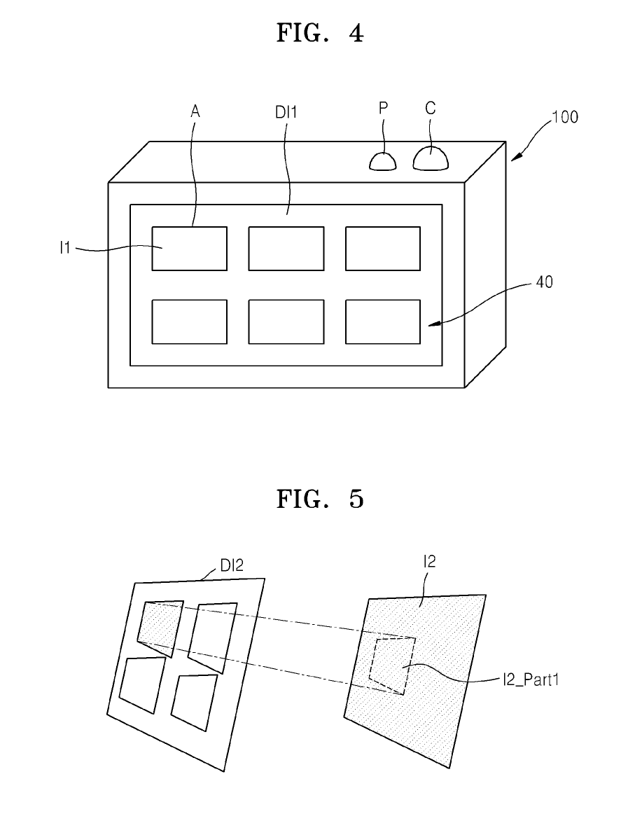

An example of applying the digital image signal processing method as described above to a digital image signal processing apparatus will be described below with reference to FIGS. 4 through 6. In the current embodiment, a digital camera is used as an example of a digital image signal processing apparatus.

First, referring to FIG. 4, a display unit 40 is arranged on a rear surface of a digital camera 100, and a power button P and a shutter-release button C are arranged on a top surface of the digital camera 100. A first display image DI1 is displayed on the display unit 40.

The first display image DI1 includes a plurality of display areas A. First images I1 are arranged in the plurality of display areas A. The size of the display areas A may be the same as the size of the first images I1. Therefore, the first images I1 may be fully displayed in the display areas A.

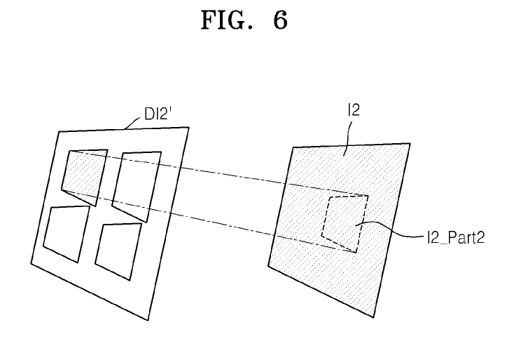

Referring to FIG. 5, a second display image DI2 displayed on the display unit 40 is shown. The second display image DI2 includes at least one second image I2 and the display areas A. In the current embodiment, the second display image DI2, in which the second image I2 is displayed in the upper-left display area A and the first images I1 other than the first image I1 replaced by the second image I2 are displayed in the remaining display areas A, is shown. The second image I2 corresponds to a selected first image I1. In other words, the selected first image I1 and the second image I2 depict the same scene and have different sizes. The second image I2 may be an enlarged portion of the same subject in the first image I1. The second image I2 may either from the same source image as first image I1 or from another source image of the same subject as first image I1. The selected first image I1 and the second image I2 may be stored in the same image file. The second image I2 is a larger image than the selected first image I1, and only a portion of the second image I2 may be displayed in the upper-left display area A. For example, in the second display image DI2, a portion I2_Part1 of the second image I2 corresponding to the selected first image I1 is displayed in one of the display areas A, specifically the upper-left display area A, and the unselected first images I1 are displayed in the remaining display areas A. The size of the portion I2_Part1 of the second image I2 corresponds to the size of the display areas A, and thus the size of the portion I2_Part1 of the second image I2 may be substantially the same as the size of the first images I1. Referring to FIG. 6, another second display image DI2′ is shown. In the other second display image DI2′, another portion I2_Part2 of the second image I2 is displayed in the upper-left display area A. For example, according to a replacement control signal, the portion I2_Part1 of the second image I2 displayed in the upper-left display area A may be replaced with the other portion I2_Part2 of the second image I2. The size of the other portion I2_Part2 of the second image I2 also corresponds to the size of the display areas A, and thus the size of the other portion I2_Part2 of the second image I2 may also be substantially the same as the size of the first images I1.

The portion I2_Part1 and the other portion I2_Part2 of the second image I2 may respectively include face areas of persons detected in the second image I2. Detailed descriptions thereof will be given below with reference to attached drawings.

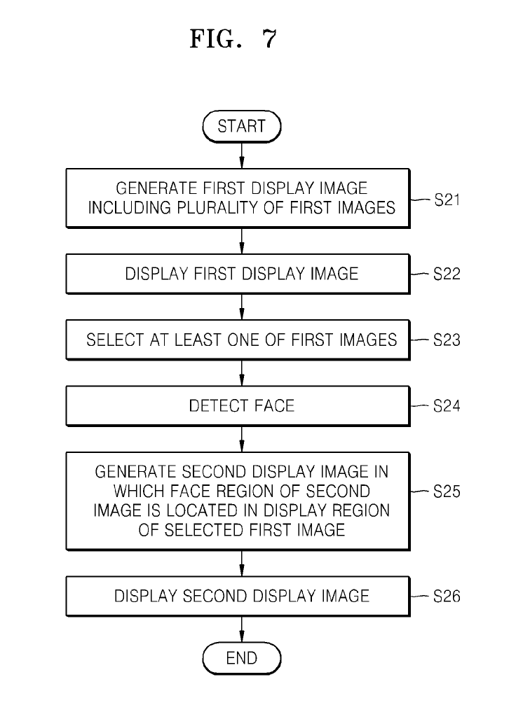

A digital image signal processing method according to another embodiment of the invention will be described below with reference to FIG. 7. Descriptions below will focus on differences between the embodiment shown in FIG. 4 and the embodiment shown in FIG. 7.

Referring to FIG. 7, a first display image including a plurality of first images is generated (operation S21). The first images have a first size.

Next, the first display image is displayed (operation S22).

One of the first images included in the first display image is selected (operation S23). The selection may be either performed automatically by a particular program or manually by a user.

A face is detected in the selected first image (operation S24). Although a face is detected in the current embodiment, a particular object or a particular scene may instead be detected and an image of a detected area may be generated. A face area may be detected by acquiring information regarding the face area from an image file in which the first image is stored. Alternatively, information regarding the face area may be detected by executing a face detecting program with respect to the first image, a second image having a second size, or an original image. Based on the information, a face area may be detected in the second image.

A second display image including a second image including at least a portion of the face area is generated (operation S25). The second image is displayed in a display area of the selected first image. The second display image may include the unselected first images and the second image, which corresponds to the selected first image.

The generated second display image is displayed (operation S26).

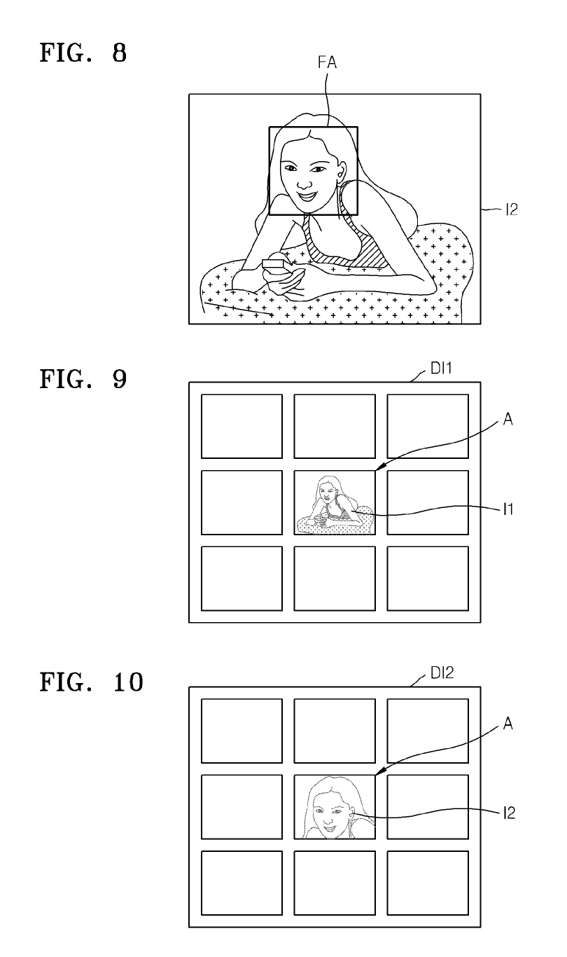

The digital image signal processing method shown in FIG. 7 will be described in closer detail with reference to FIGS. 8 through 10.

First, referring to FIG. 8, an example of a second image I2 having a second size is shown. A face area FA is detected in the second image I2. The face area FA may be detected in the second image I2 based on information regarding the face area FA detected in a first image I1 having a first size, wherein the first size is smaller than the second size, or an original image. Alternatively, information regarding the face area FA may be detected in an image file, and the face area FA may be detected in the second image I2 based on the information.

Referring to FIG. 9, a first display image DI1 including the first image I1 having the first size is shown. The entire first image I1 may be displayed in a display area A. The size of the display area A may be substantially the same as the size of the first image I1. The first display image DI1 includes a plurality of images.

Next, referring to FIG. 10, when the first image I1 at the center of the first display image DI1, a portion of the second image I2 corresponding to the first image I1 is displayed in the display area A in a second display image DI2.

The portion of the second image I2 included in the second display image DI2 includes the face area FA. In the current embodiment, the portion of the second image I2 corresponds to the first image I1, where the size of the portion corresponds to the size of the display area A. Here, the portion is not a randomly selected portion, but a portion including the face area FA.

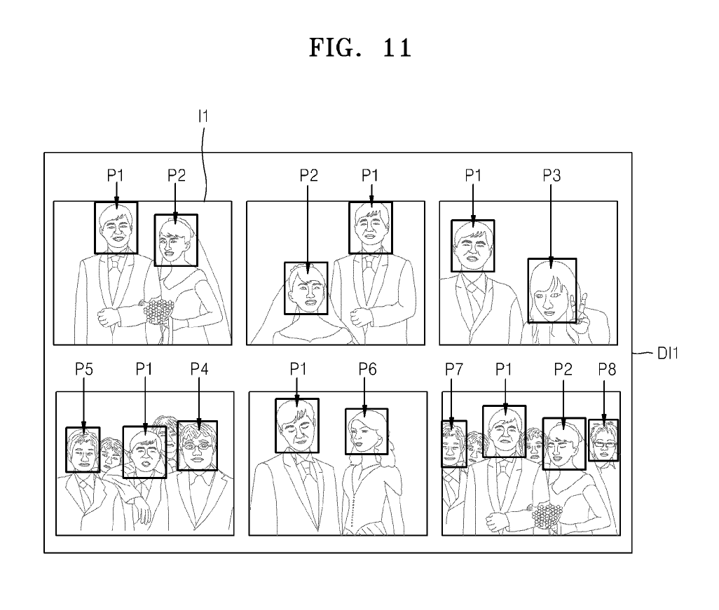

FIGS. 11 through 13 are diagrams for describing a digital image signal processing method according to another embodiment of the invention.

Referring to FIG. 11, a first display image DI1 including a plurality of first images I1 is displayed. The first images I1 depict scenes at a wedding, and more particularly, depict scenes including a groom P1 and a bride P2 and/or guests P3 through P8.

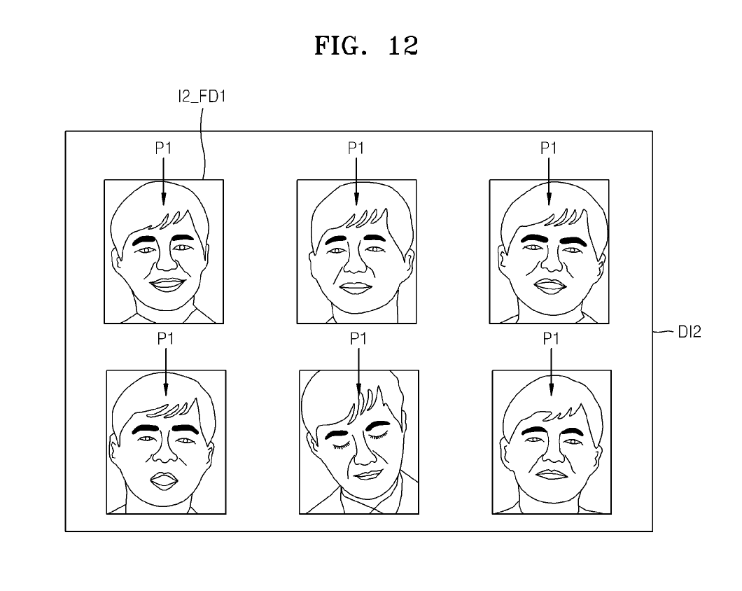

Referring to FIG. 12, a second display image DI2 includes second images I2 having face areas I2_FD1 of the groom P1. In the current embodiment, the second display image DI2 includes the second images I2 corresponding to the first images I1 in the first display image DI1. In the current embodiment, the six first images I1 depict the groom P1, and thus the second display image DI2 including the second images I2 having the face areas I2_FD1 respectively corresponding to the six first images I1 is displayed. The second images I2 corresponds to the first images I1 and has a second size that is larger than the first size of the first images I1. In detail, the face areas I2_FD1 of the groom P1 detected in the second images I2 are arranged in display areas A of the corresponding first images I1. In the current embodiment, the face areas I2_FD1 have substantially the same size as the display areas A. However, the invention is not limited thereto. For example, portions of the second images I2 including portions of the face areas I2_FD1 may be displayed in the display areas A.

Furthermore, in the current embodiment, the first images I1 including a person with high priority are automatically selected or the first images I1 including a face area of a person frequently detected in the first images I1 are automatically selected. Alternatively, when the same person is detected in a plurality of the first images I2, the plurality of first images I2 may be selected.

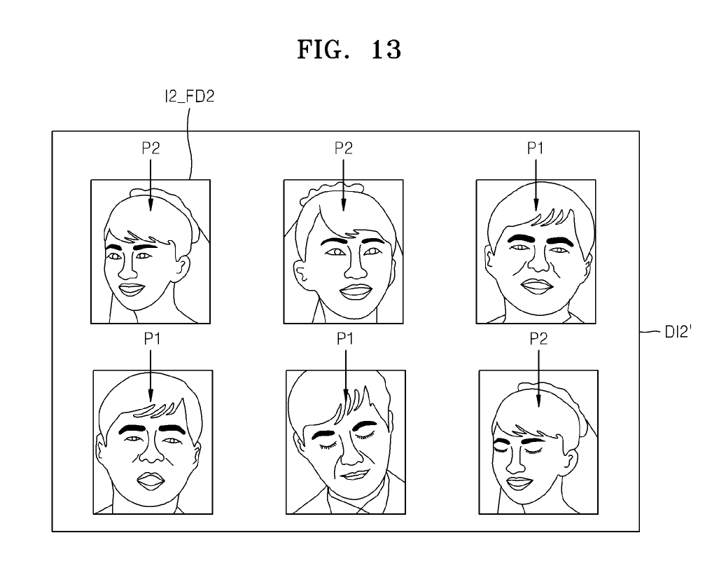

FIG. 13 shows a second display image DI2′, in which other portions of the second images I2 including portions of the face areas I2_FD2 of the bride P2 is displayed. In the current embodiment, the second display image DI2′ replaces the second images I2 in the second display image DI2 at coordinates (1, 1), (1, 2), and (2, 3) with images including portions of the face areas I2_FD2 of the bride P2. A replacement signal may be generated either automatically or manually by a user, and the second display image DI2′ may be generated by modifying the second display image DI2 based on the replacement signal.

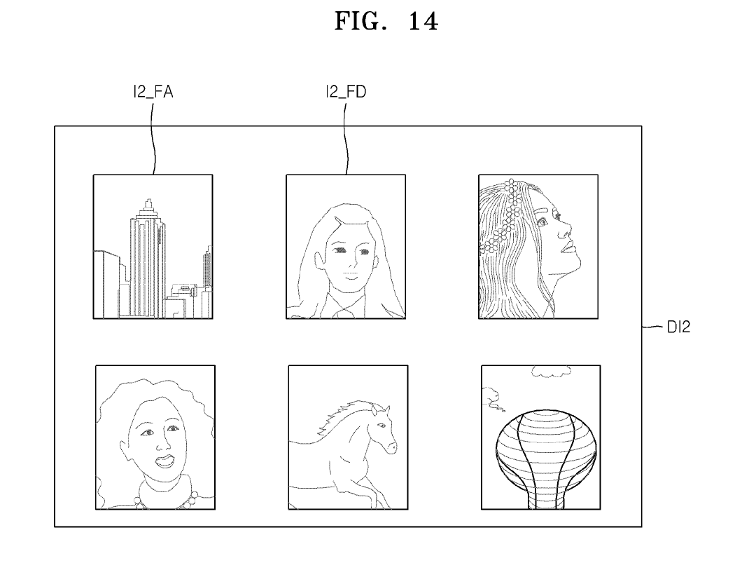

FIG. 14 is a diagram showing another second display image DI2″. In the second display image DI2″ according to the current embodiment, the face areas I2_FD of the second image DI2″ are arranged in the display areas A of the corresponding first images I1 as in the previous embodiment when the face areas I2_FD are detected, and images including portions of focus areas I2_FA of the second images I2 are arranged in the display areas A of the corresponding first images I1.

A focus area may be acquired to perform AF with the pre-processing unit 31 shown in FIG. 1. Therefore, the detecting unit may include a focus area detecting unit, and a focus area detected as described above may be used not only for performing AF, but also for generating a second display image.

According to the invention, an effect of selectively zooming in and displaying an object desired by a user, and more particularly, a face area, without interfering with display of a first image may be acquired.

The device described herein may comprise a processor, a memory for storing program data and executing it, a permanent storage such as a disk drive, a communications port for handling communications with external devices, and user interface devices, including a display, keys, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

What is claimed is:

1. A digital image signal processing method comprising:
generating a first display image in which a plurality of first images are arranged;
displaying the first display image as a single screen image;
selecting a first image from the displayed plurality of first images in the first display image;
generating a second display image comprising a second image in which a portion of the selected first image is enlarged, wherein the second image is displayed in a display area of the second display image approximately corresponding to a display area of the selected first image in the first display image; and
displaying the second display image as a single screen image.

2. The digital image signal processing method of claim 1, wherein generating a second display further comprise:
retrieving a larger sized image of the selected first image than used to generate the first display image; and
generating the enlarged portion of the selected first image from the retrieved larger sized image.

3. The digital image signal processing method of claim 1, wherein generating a second display image further comprises:
generating a second display image wherein the unselected first images are displayed in display areas of the second display image approximately corresponding to display areas of the unselected first images in the first display image.

4. The digital image signal processing method of claim 1, wherein the second image is displayed in a display area of the second display image approximately corresponding to a display area of the selected first image in the first display image, and the second image and the selected first image have approximately the same size.

5. The digital image signal processing method of claim 1, further comprising:
generating another second display image comprising a second image in which a different portion of the selected first image is enlarged, wherein the second image is displayed in a display area of the second display image approximately corresponding to a display area of the selected first image in the first display image; and
displaying the another second display image as single screen image.

6. The digital image signal processing method of claim 1, further comprising:
detecting an object area in the selected first image, and wherein the portion of the selected first image enlarged comprises at least some of the object area.

7. The digital image signal processing method of claim 1, further comprising detecting a face area in the selected first image, and wherein the portion of the selected first image enlarged comprises at least some of the detected face area.

8. The digital image signal processing method of claim 1, further comprising:
selecting a plurality of first images from the first images;
detecting a plurality of face areas in each of the selected first images, and wherein the step generating a second display image comprises:
generating a second display image comprising second images in which a portion of the corresponding selected first image is enlarged, wherein each of the second images is displayed in a display area of the second display image approximately corresponding to a display area of the corresponding selected first image in the first display image, and wherein the portion of the corresponding selected first image enlarged comprises at least a part of the corresponding detected face area of the plurality of face areas, if a face area is detected in the corresponding selected first image.

9. The digital image signal processing method of claim 8, wherein the face areas depict faces of a single person.

10. The digital image signal processing method of claim 1, further comprising:
selecting a plurality of first images from among the first images;
detecting face areas in each of the selected first images, and wherein the step generating a second display image comprises:
generating a second display image comprising a plurality of second images in which a portion of the corresponding selected first image is enlarged, wherein each of the second images is displayed in a display area of the second display image approximately corresponding to a display area of the corresponding selected first image in the first display image, and wherein the portion of the corresponding selected first image enlarged is a face if a face is detected, and if a face is not detected then the portion of the corresponding selected first image enlarged is one of: an object detected in the corresponding first image, a focus area detected in the corresponding first image, and an area of the corresponding first image.

11. The digital image signal processing method of claim 1, further comprising detecting a focus area for the selected first image, wherein the portion of the selected first image enlarged is at least part of the focus area.

12. A non-transitory computer readable recording medium having recorded thereon computer readable instruction, that when executed by a computer cause the computer to execute the method of claim 1.

13. A digital image signal processing apparatus comprising:
a first display image generating unit configured to generate a first display image, in which a plurality of first images having a first size are arranged in a single screen image;
a selecting unit configured to select at least one of the plurality of first images in the first display image;
a second display image generating unit configured to generate a second display image, in which a second image that corresponds to the selected first image and has a second size larger than the first size is arranged in a display area of the selected first image; and
a display unit for displaying the second display image.

14. The digital image signal processing apparatus of claim 13, further comprising:
a first image detecting unit configured to detect the selected first image in an image file including the selected first image and the second image, wherein the images depict a single scene and having different sizes; and
a second image detecting unit for detecting the second image in the image file.

15. The digital image signal processing apparatus of claim 13, wherein the second display image generating unit is further configured to generate the second display image, in which the unselected first images are displayed, and the second image is displayed in the display area of the selected first image.

16. The digital image signal processing apparatus of claim 13, wherein the second display image generating unit is further configured to generate the second display image, in which a portion of the second image is displayed in the display area of the selected first image, and wherein the size of the portion of the second image corresponds to the size of the display area of the selected first image.

17. The digital image signal processing apparatus of claim 16, wherein the second display image generating unit is further configured to generate another second display image, in which the portion of the second image displayed in the display area of the selected first image is replaced with another portion of the second image, wherein the size of the other portion of the second image corresponds to the size of the display area of the selected first image.

18. The digital image signal processing apparatus of claim 16, further comprising an object detecting unit configured to detect an object area with respect to the at least one selected first image, wherein the second display image generating unit is configured to generate a second display image, in which the portion of the second image comprises at least a portion of the object area.

19. The digital image signal processing apparatus of claim 16, further comprising a face detecting unit configured to detect a face area with respect to the at least one selected first image, wherein the second display image generating unit is further configured to generate a second display image, in which the portion of the second image comprises at least a portion of the face area.

20. The digital image signal processing apparatus of claim 19, wherein the selecting unit is further configured to select a plurality of first images from among the first images, the face detecting unit is further configured to detect face areas corresponding to each of the selected first images, and the second display image generating unit is further configured to generate a second display image, in which portions of second images respectively corresponding to the selected first images are arranged in display areas of the corresponding selected first images.

21. The digital image signal processing apparatus of claim 20, wherein the face areas respectively corresponding to the selected first images depict faces of a single person.

22. The digital image signal processing apparatus of claim 19, wherein
the face detecting unit is configured to detect face areas corresponding to each of the selected first image, and
the second display image generating unit is configured to generate a second display image, in which the portions of the second images are replaced with other portions of the second images including at least a portion of face areas of a person different from the person corresponding to the face areas included in a previous second display image.

23. The digital image signal processing apparatus of claim 16, further comprising a focus area detecting unit configured to detect a focus area with respect to the at least one selected first image,
wherein the second display image generating unit is further configured to generate a second display image, in which the portion of the second image comprises at least a portion of the focus area.
